(19) United States
(12) Patent Application Publication
(10) Pub. No.: US 2011/0077983 A1
(43) Pub. Date: Mar. 31, 2011

(54) FLIGHT CHECK-IN VIA A TELECOMMUNICATION NETWORK

(76) Inventors: Suzann Hua, Lisle, IL (US); Ahmed N. Zaki, Lisle, IL (US)

(21) Appl. No.: 12/570,222

(22) Filed: Sep. 30, 2009

(51) Int. Cl. G06Q 10/00

(52) U.S. Cl. 705/5

(57) ABSTRACT

Flight check-in systems and associated methods are disclosed. A passenger is able to check in with an airline by initiating a call to a phone number designated for flight check-in. A flight check-in system receives the call initiated by the passenger and identifies a number (e.g., a phone number) based on the call. Based on the number, the flight check-in system identifies a flight reservation associated with the passenger. Subsequently, the flight check-in system generates a virtual boarding pass based on the flight reservation, and sends the virtual boarding pass to a gate at an airport for the passenger to board a flight.

### BACKGROUND

1. Field of the Invention

The invention is related to the field of communications and, in particular, to flight check-in.

2. Statement of the Problem

According to the Transportation Security Administration (“TSA”), over 600 million passengers fly each year. To ensure the security of commercial flights, a passenger first checks in with an airline to obtain a boarding pass that has a name of the passenger. At a security check point, the passenger then presents a photo identification so that a TSA security agent can match the passenger against the photo identification to verify the name of the passenger. Based on the verified name of the passenger and the boarding pass, the TSA security agent can thus verify that the passenger named on the boarding pass will board a flight.

Many airlines have made obtaining the boarding pass easier by allowing the passenger to print the boarding pass from a website. However, the passenger needs to have access to the Internet and a printer. It can be extremely inconvenient to have access to both especially when the passenger is away from home. For example, even though many hotels offer Internet access, a printer may not be available. Even when a printer is available, the printer may be in use by someone else and/or may not work properly (e.g., paper jammed, no ink, etc).

The use of paper boarding passes can also create security concerns. Because the boarding pass obtained from the Internet is usually presented using a standard mark-up language (e.g., HTML), the boarding pass can be easily forged or altered. It is thus desirable to provide an alternative to the use of paper boarding passes.

### SUMMARY

Embodiments described herein enable flight check-in using a telecommunication network. The concept of “flight check-in” described herein broadly encompasses allowing a passenger to board a flight after the passenger has purchased an airline ticket, rather than merely securing a seat on the flight. Instead of having the passenger check in online, the passenger is able to initiate a call to a flight check-in system to check in with an airline. The flight check-in system identifies a flight reservation associated with the passenger (e.g., based on the passenger's phone number that may have been associated with the flight reservation when the passenger purchased the airline ticket), and sends a virtual boarding pass based on the flight reservation to a gate at an airport for the passenger to board a flight. Advantageously, the passenger does not need to check in online and print a paper boarding pass because the virtual boarding pass is sent directly to the gate at the airport.

Additionally, the passenger may initiate another call to the flight check-in system when the passenger arrives at the airport and is located at a security checkpoint. In response to the call, the flight check-in system sends an electronic identification of the passenger to the security checkpoint. Accordingly, after a TSA security agent has matched the passenger against a photo identification of the passenger, the TSA security agent is able to match the photo identification with the electronic identification (e.g., a name of the passenger) that has been sent to the airport. The TSA security agent can thus verify that the passenger will board a flight and allow the passenger to proceed through the security checkpoint.

One embodiment is a method that includes receiving, at a flight check-in system, a call initiated by a passenger calling a phone number designated for flight check-in. The method also includes identifying a number at the flight check-in system based on the call. Additionally, the method includes identifying a flight reservation associated with the passenger based on the number. Moreover, the method includes generating a virtual boarding pass based on the flight reservation, and sending the virtual boarding pass to a gate at an airport for the passenger to board a flight.

Another embodiment is a method of sending an electronic identification of the passenger to a security checkpoint. The method includes receiving another call initiated by the passenger from a mobile device when the passenger is located at a security checkpoint of the airport. Additionally, the method includes identifying the passenger based on the other call. The method also includes identifying the security checkpoint. Moreover, the method includes sending an electronic identification of the passenger to the security checkpoint to be matched against a photo identification of the passenger.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a flight check-in system in an exemplary embodiment.

FIG. 2 is a flow chart illustrating a method for flight check-in in an exemplary embodiment.

FIG. 3 is a flow chart illustrating a method of sending an electronic identification of the passenger to a security checkpoint in an exemplary embodiment.

FIG. 4 illustrates another flight check-in system in another exemplary embodiment.

FIG. 5 illustrates another flight check-in system in yet another exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

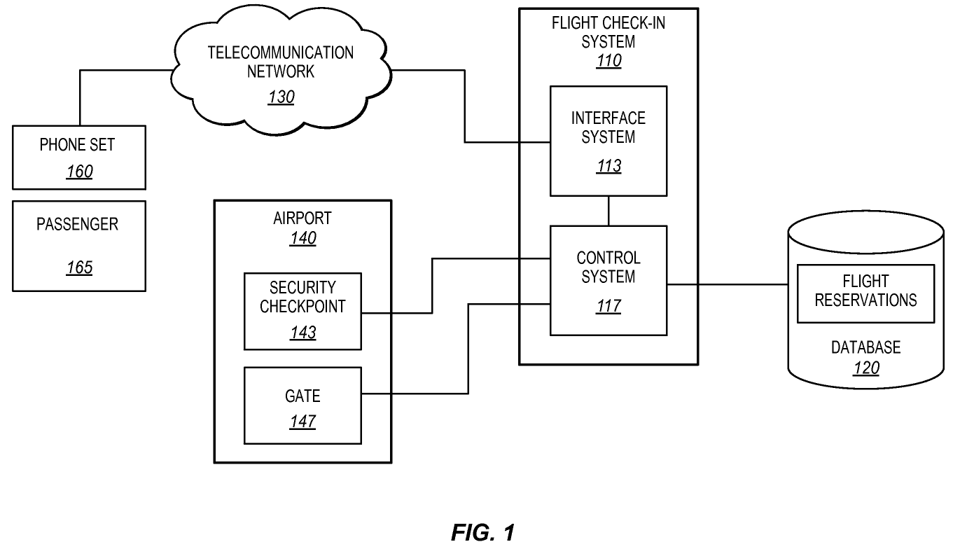

FIG. 1 illustrates a flight check-in system 110 in an exemplary embodiment. As will be discussed in greater detail, the flight check-in system 110 may be implemented within or outside of a mobile network, and may be operated by a telecommunications service provider, an airline, and/or another entity. The flight check-in system 110 may comprise any device, server, and/or function operable to support flight check-in. The flight check-in system 110 is in communication with a database 120 that is suitable to store records of flight reservations. The database 120 may be operated by the airline.

The flight check-in system 110 is coupled to a telecommunication network 130. The telecommunication network 130 may comprise a wireless network based on CDMA, GSM, WiMAX, and/or any other suitable telecommunication network. In some embodiments, the telecommunication network 130 may comprise a traditional circuit switched voice network that may support a landline. In other embodiments, the telecommunication network 130 may support Short Message Service (“SMS”) or any other text messaging service.

The flight check-in system 110 may receive the call initiated by a passenger 165 from a phone set 160 through the telecommunication network 130. The phone set 160 may comprise a cellular phone, a smartphone, or any other mobile device. In some embodiments, the phone set 160 may comprise a plain old telephone set (“POTS”) instead of a mobile device. In other embodiments, the phone set 160 may be capable of sending a text message.

The flight check-in system 110 is also able to communicate with systems within an airport 140. The airport 140 may be any airport from which the passenger 165 boards a flight. The airport 140 includes a security checkpoint 143 and a gate 147. It will be understood that the words “security checkpoint” may actually refer to a system at the security point 143, and the word “gate” may actually refer to a system at the gate 147. These systems may be stationary, but may comprise a portable device.

The flight check-in system 110 may comprise an interface system 113 and a control system 117. The interface system 113 may comprise any interface operable to receive a call from the phone set 160 through the telecommunication network 130. The control system 117 may comprise any device, server, or function operable to respond to the call from the phone set 160 and to communicate with systems within the airport 140 and the database 120.

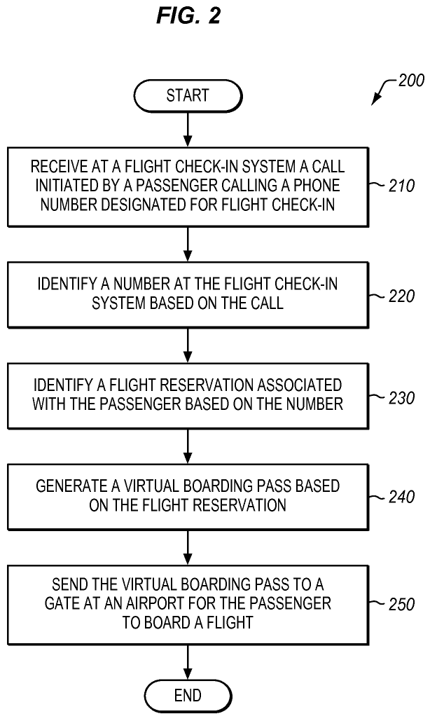

Assume for this embodiment that the passenger 165 has purchased an airline ticket from an airline to fly out of the airport 140. The corresponding flight reservation is stored in the database 120. When the passenger 165 desires to check in with the airline and/or to board a flight, the passenger 165 places a call through the phone set 160 to the flight check-in system 110. In response to the call, the flight check-in system 110 operates as described in FIG. 2.

FIG. 2 is a flow chart illustrating a method 200 of flight check-in in an exemplary embodiment. The steps of this method will be described with reference to the flight check-in system 110 of FIG. 1, but those skilled in the art will appreciate that the method 200 may be performed in other networks and systems. Also, the steps of the flow charts described herein are not all inclusive and may include other steps not shown, and the steps may be performed in an alternative order.

In step 210, the interface system 113 receives the call initiated by the passenger 165. A call may comprise a voice call, an SMS message, a Multimedia Messaging Service (“MMS”) message, or any other kind of communication that can be placed to a phone number over the telecommunication network 130. The call is placed to a phone number designated for flight check-in. For example, the phone number may comprise a 1-800 number. The phone number may also comprise a number unique for each airline for the call to be handled by different flight check-in systems or so that the flight check-in system 110 is able to identify which airline the passenger 165 is flying on based on the called phone number.

In step 220, the control system 117 identifies a number based on the call. In one embodiment, the number may be a phone number associated with the phone set 160 used by the passenger 165. The control system 117 may identify the phone number based on caller ID information received by the interface system 113. The control system 117 may also prompt the passenger to enter (e.g., touch tone) and/or speak the phone number. In another embodiment, the number may be an identifier other than the phone number. The identifier may have been generated for the passenger 165 and/or provided by the passenger 165 when purchasing the airline ticket. For example, the unique identifier may comprise a confirmation or e-ticket number, a credit card number used to purchase the airline ticket, or some other identifier.

In step 230, the control system 117 identifies a flight reservation associated with the passenger 165 based on the number. When the passenger 165 purchased the airline ticket, the corresponding flight reservation may have been associated with a number. The association may have been stored in the database 120 along with the flight reservation. Thus, the control system 117 is able to initiate a search in the database 120 based on the association and the number identified from the call to identify the flight reservation.

In step 240, the control system 117 generates a virtual boarding pass based on the flight reservation. The virtual boarding pass may comprise any electronic message that can be sent electronically to the gate 147 to identify the passenger and allow the passenger 165 to board a flight. For example, the virtual boarding pass may comprise an identifier including a name of the passenger 165. In some embodiments, the identifier may include a unique number on a photo identification including a driver's license. The virtual boarding pass may also be generated to comprise a flight number, date and time of the flight, a seat number, a gate number, and/or other identifiers including a frequently flyer number and e-ticket number, etc that are identified based on the flight reservation.

In step 250, the control system 117 sends the virtual boarding pass to the gate 147 at the airport 140 for the passenger 165 to board a flight. The flight check-in system 110 may identify a boarding system at the gate 147 and send the virtual boarding pass over a network to the boarding system. In some embodiments, another system at the airport 140 may receive the virtual boarding pass and route the virtual boarding pass to the gate 147 based on the flight number and/or the gate number in the virtual boarding pass. The boarding system at the gate 147 may display identification information (e.g., a name of the passenger 165) from the virtual boarding pass on a display device. In effect, the traditional paper boarding pass can be replaced because airline personnel are able to verify the passenger 165 against the displayed identification information and allow the passenger to board the flight.

In some embodiments, the control system 117 may further initiate a request to update a record of the flight reservation to indicate that the passenger is checked into the flight in response to receiving to the call. For example, the control system 117 may send a message to the database 120 for the record of the flight reservation to be updated to secure a seat on the flight.

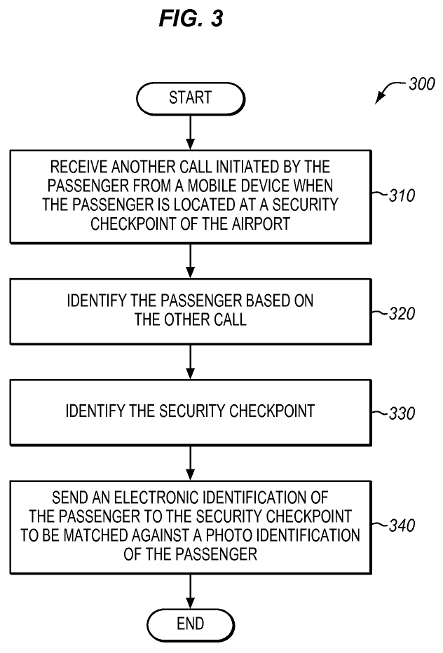

It is noted that step 250 may occur at any time after the passenger 165 has initiated the call and before the passenger needs to pass through the gate 147. Prior to the passenger passing through the gate 147, the passenger needs to first pass through the security checkpoint 143 to arrive at a boarding area. Many details about passing through the gate 147 are similar to passing through the security checkpoint 143 as will be discussed in FIG. 3.

FIG. 3 is a flow chart illustrating a method 300 of allowing the passenger 165 to pass through the security checkpoint 143 at the airport 140 in an exemplary embodiment. The steps of this method will be described with reference to the flight check-in system 110 of FIG. 1, but those skilled in the art will appreciate that the method 300 may be performed in other networks and systems.

Assume for this embodiment the passenger 165 has arrived at the airport 140, and has proceeded to the security checkpoint 143 of the airport 140. When the passenger 165 is located at the security checkpoint 143, the passenger 165 may initiate another call through the telecommunication network 130 to the flight check-in system 110. In response to the call, the flight check-in system 110 operates as described in FIG. 3.

In step 310, the interface system 113 receives the other call initiated by the passenger 165. The other call may have been placed to the same number used for flight check-in, but may have alternatively been placed to a phone number designated for the airport 140 and/or for the security checkpoint 143.

In step 320, the control system 117 identifies the passenger 165 based on the other call. For example, the control system 117 may identify a phone number of a mobile phone used by the passenger to initiate the other call. The passenger 165 may have already registered the phone number with the control system 117, so that the control system 117 can identify the passenger 165 based on the phone number.

In step 330, the control system 117 identifies the security checkpoint 143. In some embodiments, how the security checkpoint 143 is to be identified may be prominently displayed or posted for passengers who are located at the security checkpoint 143. For example, the passenger 165 may be instructed to call a particular phone number, and may be further instructed to then enter a code. The control system 117 may then identify the security checkpoint 143 based on the phone number called by the passenger 165 and/or the code entered by the passenger 165 during the call.

In another embodiment, the control system 117 may be able to identify the security checkpoint 143 by identifying a geographic location of the mobile device automatically. For example, the Global Positioning System (“GPS”) and/or a cellular tower based triangulation method may be used. To increase security, the control system 117 may verify that the security checkpoint identified based on the input (e.g., the phone number called and/or code entered) received from the passenger 165 matches the geographic location of the mobile device in yet another embodiment.

In step 340, the control system 117 sends an electronic identification of the passenger 165 to the security checkpoint 143 to be matched against a photo identification of the passenger 165. The electronic identification may comprise any electronic message that can be sent electronically to the security checkpoint 143 that identifies the passenger. For example, the electronic identification may be similar to the virtual boarding pass, and may include a name and/or a unique number on a photo identification of the passenger 165. In identifying the security checkpoint 143, the control system 117 may further identify a verification system at the security checkpoint 143, and send the electronic identification of the passenger 165 to the verification system.

The verification system at the security checkpoint 143 may display identification information (e.g., a name of the passenger 165) from the electronic identification on a display device. In effect, the traditional paper boarding pass can be replaced because a TSA security agent is able to verify the passenger 165 against the displayed identification information and allow the passenger pass through the security checkpoint 143.

It is noted that in some embodiments, the passenger 165 may place a single call for both the electronic identification to be sent to the security checkpoint 143 and the virtual boarding pass to be sent to the gate 147. In effect, several steps of FIGS. 2 and 3 may be completed in the single call.

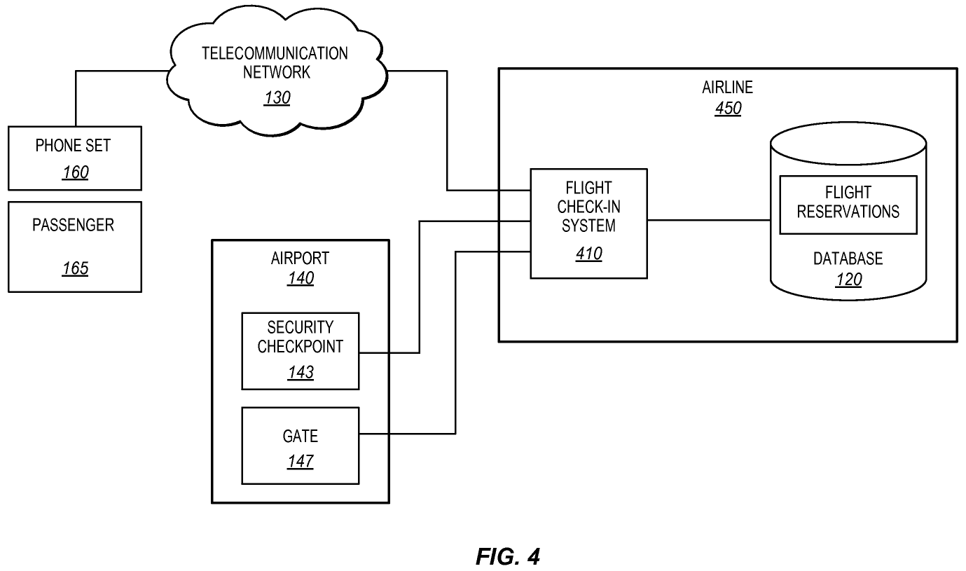

FIG. 4 illustrates another flight check-in system in another exemplary embodiment. This flight check-in system 410 is similar to the flight check-in system 110 discussed above, except the flight check-in system 410 is illustrated as being implemented within and/or operated by an airline 450 (e.g., in a back office). The airline 450, which provides air transport service, is adapted to allow the passenger 165 to check in with the airline 450 through the flight check-in system 410. The airline 450 stores the flight reservation in the database 120 of flight reservations.

In one embodiment, when the passenger 165 purchased an airline ticket, the airline 450 may store a corresponding record of a flight reservation in the database 120. Meanwhile, the flight reservation may be associated with a phone number of the phone set 160. When the passenger 165 is ready to check-in, the passenger places a call (e.g., place a voice call and/or send a text message) to the flight check-in system 410 over the telecommunication network 130, for example within 24 hours of flight departure. The call placed by the passenger 165 may be to a designated 1-800 number for the airline 450.

The flight check-in system 410 identifies the phone number of the phone set 160, for example by using caller ID, and identifies the flight reservation that is associated with the phone number of the phone set 160. The flight check-in system 410 may then initiate a request to update a record of the flight reservation to indicate that the passenger is checked into the flight to secure a seat on the flight. The passenger 165 may then receive a confirmation (e.g., voice response and/or text reply) over the phone set 160 that the passenger 165 has checked in. The passenger 165 does not need to print a board pass.

When the passenger 165 arrives at the airport 140, the passenger proceeds to the security checkpoint 143. When the passenger 165 is located at the security checkpoint 143, the passenger 165 may see instructions prominently displayed on how the security checkpoint 143 can be identified. The passenger 165 may then place a second call using the phone set 160 to a particular phone number, and may then enter a code that identifies the security checkpoint 143.

The flight check-in system 410 receives the second call and identifies both the passenger 165 and the security checkpoint 143. For example, the passenger may be identified based on the caller ID of the phone set 160. The flight check-in system 410 then sends an electronic identification of the passenger to the security checkpoint 143. A verification system at the security checkpoint 143 in turn displays identification information (e.g., a name of the passenger 165) from the electronic identification on a display device. Based on the displayed identification information, a TSA security agent is then able to verify that the passenger 165 will board a flight without using a paper boarding pass, and allow the passenger 165 to pass through the security checkpoint 143.

The passenger 165 then proceeds to a boarding area. At any time prior to the time of boarding the flight through the gate 147, the flight check-in system 410 sends a virtual boarding pass to the gate 147. The virtual boarding pass may have been generated based on the flight reservation in the database 120. A boarding system at the gate 147 may display identification information (e.g., a name of the passenger 165) from the virtual boarding pass for airline personnel to allow the passenger 165 to board the flight by passing through the gate 147.

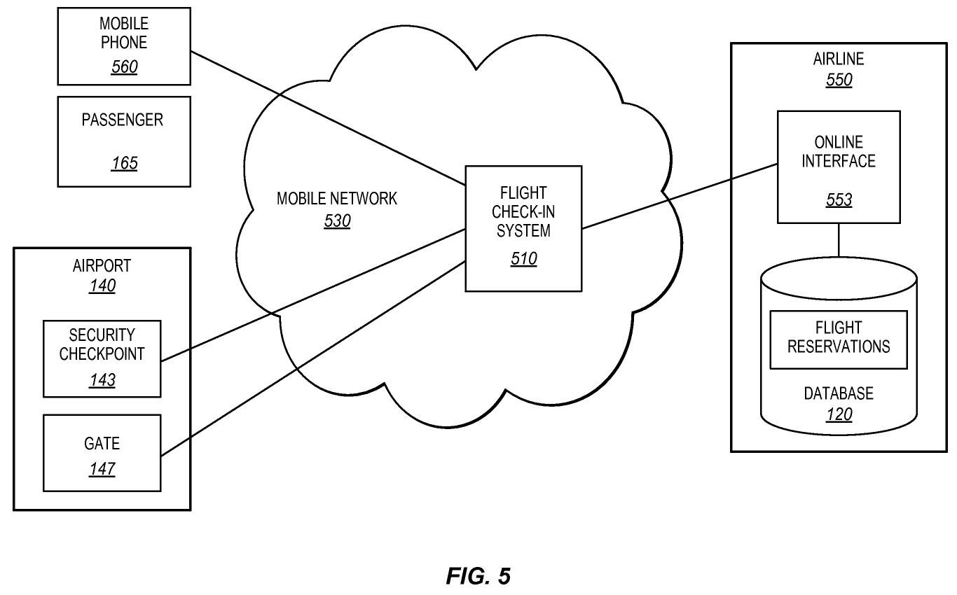

FIG. 5 illustrates another flight check-in system in yet another exemplary embodiment. The flight check-in system 510 is implemented within a mobile network 530. The flight check-in system 510 is similar to the flight check-in system 110 of FIG. 1, except the flight check-in system 510 is operable in the mobile network 530, for example, as a network element. The flight check-in system 510 may be operated by a telecommunications service provider. The telecommunications service provider may comprise any provider of telecommunications service. For example, the telecommunications service provider may comprise a local exchange carrier and/or a mobile wireless provider. The telecommunications service provider is adapted to allow a passenger 165 to check in with an airline 550 through the flight check-in system 510. The telecommunications service provider may provide this check-in service as an additional feature similar to 3-way calling, video on demand, etc.

The airline 550 provides an online interface 553 that allows the passenger 165 to access the flight reservation and/or to check-in after the passenger 165 has purchased an airline ticket. The passenger 165 may also have an account at the airline 550 that can be accessed through the online interface 553. The online interface 553 may comprise any device, server, or function that may be accessed using standard and/or proprietary protocols on the Internet and/or a private network. For example, the online interface 553 may comprise a website that may be accessed using the Hypertext Transfer Protocol (“HTTP”) over the Internet. The online interface 553 may also be provided to allow other entities, including a computer reservation system or a travel agent, to access the database 120 over a travel reservation network.

In an embodiment, after the passenger 165 has purchased an airline ticket, the passenger 165 may register with the flight check-in system 510 an association between a phone number of the mobile phone 560 and a flight reservation that corresponds with the airline ticket. Information related to the flight reservation, as stored with the flight check-in system 510, may include information about the name of the airline, a ticket confirmation number, and/or a name of the passenger 165, for example. Alternatively or in addition, the passenger 165 may have created an account at the flight check-in system 510 and have stored in the account information on accessing an account of the passenger 165 at the airline 550. The account at the flight check-in system 510 may be associated with the phone number of the mobile phone 560. The stored information on accessing the account at the airline 550 may include an identification of the passenger and a password.

When the passenger 165 places a call to the flight check-in system 510 from the mobile phone 560 to check in, the flight check-in system 510 in effect acts as a proxy server between the passenger 165 and the online interface 553 to allow the passenger 165 to access the online interface 553 using the mobile phone 560. For example, the flight check-in system 510 may first identify the phone number of the mobile phone 560, and then use the phone number to identify either the information related to the flight reservation and/or the information on accessing the account at the airline 550. The flight check-in system 510 may then identify the online interface 553, which may comprise identifying a network address (e.g., a Uniform Resource Locator and/or an Internet Protocol address) of the online interface 553.

In one instance, the flight check-in system 510 may send a message through the online interface 553 to identify the flight reservation using the ticket confirmation number and the name of the passenger 165. In another instance, the flight check-in system 510 may send a message through the online to log into the account of the passenger 165 at the airline 550. The flight check-in system 510 may then receive a message (from the online interface 553) about one or more flight reservations, and then identify a particular flight reservation on a flight that the passenger 165 is to board.

In one instance, the flight check-in system 510 may then initiate a request through the online interface 553 for the passenger 165 to check into the flight. Consequently, the flight check-in system 510 would receive a boarding pass (e.g., generated by the airline 550 based on the flight reservation) electronically from the online interface 553. Normally, the boarding pass is presented using a standard mark-up language (e.g., HTML) and is to be printed. Instead, the flight check-in system 510 captures and saves the received boarding pass. Using information from the received boarding pass, the flight check-in system 510 generates an electronic identification that is sent to the security checkpoint 143, and also generates a virtual boarding pass that is sent to the gate 147. In another instance, the flight check-in system 510 may receive information about the flight reservation from the online interface 553, rather than receiving the boarding pass by actually checking into the flight.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A method comprising:
receiving, at a flight check-in system, a call initiated by a passenger calling a phone number designated for flight check-in;
identifying a number at the flight check-in system based on the call;
identifying a flight reservation associated with the passenger based on the number;
generating a virtual boarding pass based on the flight reservation; and
sending the virtual boarding pass to a gate at an airport for the passenger to board a flight.

2. The method of claim 1, further comprising:
receiving another call initiated by the passenger from a mobile device when the passenger is located at a security checkpoint of the airport;
identifying the passenger based on the other call;
identifying the security checkpoint; and
sending an electronic identification of the passenger to the security checkpoint to be matched against a photo identification of the passenger.

3. The method of claim 2, wherein identifying the security checkpoint comprises receiving an identification of the security checkpoint from the passenger during the other call.

4. The method of claim 2, wherein identifying the security checkpoint comprises:
identifying a geographic location of the mobile device; and
identifying the security checkpoint based on the geographic location of the mobile device.

5. The method of claim 1, further comprising:
initiating a request based on the call to update a record of the flight reservation to indicate that the passenger is checked into the flight.

6. The method of claim 1, wherein the virtual boarding pass comprises a name of the passenger.

7. The method of claim 1, wherein the number comprises a phone number associated with a phone set used by the passenger to initiate the call.

8. The method of claim 1, wherein identifying the flight reservation comprises:
identifying an online interface of an airline that is associated with the flight reservation;
sending a message through the online interface to log into an account of the passenger; and
identifying the flight reservation based on a message received through the online interface.

9. The method of claim 8, further comprising:
storing an identification of the passenger and a password for accessing the online interface of the airline.

10. A flight check-in system comprising:
an interface system operable to receive a call initiated by a passenger calling a phone number designated for flight check-in; and
a control system operable to identify a number based on the call, to identify a flight reservation associated with the passenger based on the number, to generate a virtual boarding pass based on the flight reservation, and to send the virtual boarding pass to a gate at an airport for the passenger to board a flight.

11. The flight check-in system of claim 10, wherein:
the interface system is further operable to receive another call initiated by the passenger from a mobile device when the passenger is located at a security checkpoint of the airport; and
the control system is further operable to identify the passenger based on the other call, to identify the security checkpoint, and to send an electronic identification of the passenger to the security checkpoint to be matched against a photo identification of the passenger.

12. The flight check-in system of claim 11, wherein the control system is further operable to receive an identification of the security checkpoint from the passenger during the other call.

13. The flight check-in system of claim 11, wherein the control system is further operable to identify a geographic location of the mobile device, and to identify the security checkpoint based on the geographic location of the mobile device.

14. The flight check-in system of claim 10, wherein the control system is further operable to initiate a request based on the call to update a record of the flight reservation to indicate that the passenger is checked into the flight.

15. The flight check-in system of claim 10, wherein the virtual boarding pass comprises a name of the passenger.

16. The flight check-in system of claim 10, wherein the number comprises a phone number associated with a phone set used by the passenger to initiate the call.

17. The flight check-in system of claim 10, wherein the control system is further operable to identify an online interface of an airline that is associated with the flight reservation, to send a message through the online interface to log into an account of the passenger, and to identify the flight reservation based on a message received through the online interface.

18. The flight check-in system of claim 17, wherein the control system is further operable to store an identification of the passenger and a password for accessing the online interface of the airline

19. A method comprising:
receiving, at a flight check-in system, a call initiated by a passenger calling a phone number designated for flight check-in;
identifying a number at the flight check-in system based on the call;
identifying an online interface of an airline based on the call;
identifying a flight reservation associated with the passenger based on the number by sending a message through the online interface;
generating a virtual boarding pass based on the flight reservation; and
sending the virtual boarding pass to a gate at an airport for the passenger to board a flight.

20. The method of claim 19, further comprising:
receiving another call initiated by the passenger from a mobile device when the passenger is located at a security checkpoint of the airport;
identifying the passenger based on a phone number associated with the mobile device;
identifying the security checkpoint; and
sending an electronic identification of the passenger to the security checkpoint to be matched against a photo identification of the passenger.
